(19) United States
(12) Patent Application Publication
(10) Pub. No.: US 2005/0024371 A1
(43) Pub. Date: Feb. 3, 2005

(54) Display data transfer apparatus and method

(76) Inventors: Masaki Horiuchi, Hirakata (JP); Hidehito Koizumi, Neyagawa (JP); Tetsuya Takahashi, Sapporo (JP)

Correspondence Address: WENDEROTH, LIND & PONACK, L.L.P., 2033 K STREET N. W., SUITE 800, WASHINGTON, DC, 20006-1021, US

(21) Appl. No.: 10/887,841

(22) Filed: Jul. 12, 2004

(30) Foreign Application Priority Data
Jul. 31, 2003 (JP) 2003-283745

(51) Int. Cl. G06F 12/06; G06F 13/00; G06T 15/00; G09G 5/36; G06T 15/40

(52) U.S. Cl. 345/571; 345/522; 345/422; 345/537

(57) ABSTRACT

A receiving section 11 instructs a rendering section 12 to re-render display data of a portion of an image which requires updating. In response to the instruction, the rendering section 12 re-renders relevant display data stored in a display data storage section 13. In the display data storage section 13, the display data is re-rendered and also update information is stored. A display data transfer section 15 inquires, when transferring display data, of a contiguous-region detection section 14 about a range of data regions to be transferred. The contiguous-region detection section 14 specifies, based on the update information, a set of contiguous regions containing all the updated display data which is included in physical memory, and notifies the display data transfer section 15 about the specified contiguous regions. The display data transfer section 15 transfers to a display section 16 the data contained in the contiguous regions at a time.

### BACKGROUND OF THE INVENTION

1. Field of the Invention

The present invention relates to a display data transfer apparatus and method, and more particularly to a display data transfer apparatus for transferring display data stored in physical memory to display the display data on a display screen represented by a CRT or liquid crystal display, and a display data transfer method.

2. Description of the Background Art

Conventionally, in information processing apparatuses or systems such as computers having display apparatuses such as CRTs or liquid crystal displays, display data for one screen is periodically transferred to the display apparatus for display, whereby changes in display data are displayed on the screen. However, in an information processing apparatus or system in which hardware performance, such as CPU and bus speeds, is poor, the process of transferring display data for one screen whose volume is large to the display apparatus at a time may degrade the system performance. In addition, in apparatuses or systems, such as mobile phones, whose operation is assumed to be performed by batteries, the power consumed by frequent repetition of the transfer process of such large-volume display data may reduce continuous operating time.

In order to solve the above-described problems, techniques have been suggested for transferring, upon updating display data, only a portion of the display data having been updated. Such techniques are disclosed in Japanese Laid-Open Patent Publication No. 11-65813, for example. FIG. 8 is a block diagram illustrating an exemplary configuration of a conventional display data transfer apparatus disclosed in the aforementioned publication.

In FIG. 8, the conventional display data transfer apparatus includes a receiving section 110, a rendering section 120, a display data storage section 130, a display data transfer section 150, and a display section 160. The receiving section 110 receives background information and additional information. In contrast to the background information which does not involve temporal change, the additional information includes information which involves temporal change such as, for example, the position of your car in a car navigation system. The rendering section 120 controls rendering based on background information and additional information. The display data storage section 130 has a dynamic rendering region 131 for storing additional information and a background rendering region 132 for storing background information. The display data storage section 130 stores additional information and background information which compose display data for one screen. The display data transfer section 150 transfers display data stored in the dynamic rendering region 131 to display the display data on a display screen of the display section 160.

In the conventional display data transfer apparatus thus configured, when additional information received by the receiving section 110 has been updated, the rendering section 120 determines a portion of display data stored in the dynamic rendering region 131 which requires re-rendering. The rendering section 120 then performs re-rendering of the updated display data on the determined portion of display data. After completion of re-rendering, the display data transfer section 150 transfers only the portion of display data having been re-rendered to the display section 160 from the dynamic rendering region 131, thereby redisplaying the re-rendered display data on the screen.

The above-described configuration, however, has a problem that in the case where the portion of re-rendered display data is physically noncontiguous in the dynamic rendering region 131, a DMA transfer mode which does not requires CPU processing cannot be used, resulting in an increase in the amount of CPU processing. This problem will be described below using an example illustrating a general relationship between the position of a pixel on a display screen and a storage region which stores display data of the pixel in physical memory (e.g., RAM). FIG. 9 is a schematic diagram illustrating an exemplary relationship between pixel positions on the display screen of the display section 160 and regions provided in the display data storage section 130 and storing display data of the pixels.

As is well known, in display apparatuses such as CRTs or liquid crystal displays, display data for one screen which is scanned line by line from a top-left pixel 921 of a screen 92 to a bottom-right pixel 92n (n is an arbitrary integer) is stored in data regions whose physical addresses are contiguous in a physical memory 94. Therefore, as shown in FIG. 9, display data of pixels 92a to 92i which are taken as one block with a size of 3×3 pixels on the screen 92 is separately stored in three data regions (hatched portions), 94a to 94c, 94d to 94f, and 94g to 94i, whose physical addresses are not contiguous in the physical memory 94.

The display data thus stored separately needs to be transferred in such a manner that first the display data stored in the data regions 94a to 94c is transferred, and then the display data stored in the data regions 94d to 94f is transferred, and finally the display data stored in the data regions 94g to 94i is transferred. That is, the display data transfer process is performed three times.

Moreover, in the above-described conventional configuration, the display data transfer to the display section 160 by the display data transfer section 150 occurs at least one time with respect to one re-rendering process performed on the dynamic rendering region 131 by the rendering section 120. In general computer systems, are-rendering from the rendering section 120 to the dynamic rendering region 131 means a writing of data to physical memory, and a display data transfer to the display section 160 from the dynamic rendering region 131 means a reading of data from the physical memory. Therefore, in systems, such as computer games, in which re-rendering is frequently performed by user's operations, etc., writing and reading of data to/from physical memory are frequently performed. Accordingly, in systems, such as mobile phones, having a memory bus with poor transfer performance connected to physical memory, the system performance is degraded.

### SUMMARY OF THE INVENTION

Therefore, an object of the present invention is to provide a display data transfer apparatus and method which realize an improvement in system performance by transferring a plurality of re-rendered display data blocks which are noncontiguously stored in physical memory to a display section so as to include the data blocks in physically contiguous regions.

The present invention has the following features to attain the object mentioned above.

A first aspect of the present invention is directed to a display data transfer apparatus for transferring display data for screen display to a display apparatus. To achieve the aforementioned object, the display data transfer apparatus of the present invention comprises a display data storage section, a rendering section, a contiguous-region detection section, and a display data transfer section.

The display data storage section stores display data for one screen of the display apparatus. The rendering section renders and stores in the display data storage section display data to be inputted. The contiguous-region detection section detects display data whose rendering content has been updated from the display data stored in the display data storage section, and specifies contiguous regions which include all regions having stored therein the updated display data and have contiguous physical addresses. The display data transfer section transfers to the display apparatus the display data stored in the contiguous regions specified by the contiguous-region detection section.

As the trigger for starting display data transfer by the display data transfer section, after the rendering section has completed the rendering and storing of the display data, the rendering section may provide an instruction permitting transfer execution to the display data transfer section.

In addition, there may be further provided an update detection section for detecting whether there has been an update to rendering content of the display data stored in the display data storage section; and a periodic update section for inquiring of the update detection section on a predetermined periodic basis whether there has been an update and providing, if there has been an update, an instruction permitting transfer execution to the display data transfer section.

In this case, it is desirable to further provide a data transfer inhibiting section for providing an instruction inhibiting transfer execution to the display data transfer section in the case where the rendering section is under a process of rendering and storing display data in the display data storage section.

Typically, the contiguous regions may be represented by offset information providing a lowest physical address of the physical addresses which indicate the storage regions of the updated display data in the display data storage section, and size information providing a range of the updated display data from the lowest physical address to a highest physical address.

In addition, the contiguous regions may be represented by starting pixel information providing the smallest X and Y coordinates of the updated display data and ending pixel information providing the largest X and Y coordinates of the updated display data, the X and Y coordinates being obtained when the updated display data is displayed as pixels on a screen of the display apparatus.

Alternatively, the contiguous regions may be represented by starting pixel information providing the X and Y coordinates of a pixel, at least one coordinate being smaller than the smallest X or Y coordinate of the updated display data, and ending pixel information providing the largest X and Y coordinates of the updated display data, the X and Y coordinates being obtained when the updated display data is displayed as pixels on a screen of the display apparatus.

Moreover, the contiguous regions may be represented by starting pixel information providing the X and Y coordinates of a pixel, at least one coordinate being smaller than the smallest X or Y coordinate of the updated display data, and ending pixel information providing the X and Y coordinates of a pixel, at least one coordinate being larger than the largest X or Y coordinate of the updated display data, the X and Y coordinates being obtained when the updated display data is displayed as pixels on a screen of the display apparatus.

The processes performed by individual components of the above-described display data transfer apparatus can be taken as a display data transfer method which provides a series of processing steps. Specifically, a display data transfer method comprises the steps of: rendering and storing in a display data storage section display data to be inputted; detecting display data whose rendering content has been updated from the display data stored in the display data storage section; specifying contiguous regions which include all regions having stored therein the updated display data and have contiguous physical addresses; and transferring to the display apparatus the display data stored in the specified contiguous regions.

The above-described display data transfer method can be provided in the form of a program for allowing a computer to perform a series of processing steps. The program may be installed on a computer through a computer-readable storage medium having stored thereon the program.

As described above, according to the present invention, when there has been an update to display data of an image, contiguous regions containing the updated display data are specified. This makes it possible to transfer the contiguous regions to the display section by a single DMA transfer even when the update to the display data is partial. Accordingly, a frequent reading of data from the physical memory can be avoided, and thus an updated image can be displayed without increasing CPU load.

In addition, contiguous regions containing updated display data are transferred to the display section on a predetermined periodic basis. This makes it possible to transfer the contiguous regions containing display data having been updated in a predetermined periodic time to the display section by a single DMA transfer even when re-rendering occurs frequently in a short period of time.

Moreover, when a re-rendering process is underway, transfer of contiguous regions containing updated display data to the display section is inhibited. This makes it possible to avoid a situation where an incomplete image which is under the process of updating is displayed on the screen of the display section even in the case where a predetermined period is reached while display data for one screen is being written to the display data storage section.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a display data transfer apparatus according to a first embodiment of the present invention;

FIG. 2 is a flowchart showing the processing steps of a display data transfer method according to the first embodiment of the present invention;

FIG. 3 is a schematic diagram showing an exemplary relationship between pixel positions on a display screen of a display section 16 of FIG. 1 and storage regions 33 which are provided in a display data storage section 13 and which store display data of the pixels;

FIG. 4 is a block diagram illustrating a configuration of a display data transfer apparatus according to a second embodiment of the present invention;

FIG. 5 is a flowchart showing the processing steps of a display data transfer method according to the second embodiment of the present invention;

FIG. 6 is a block diagram illustrating a configuration of a display data transfer apparatus according to a third embodiment of the present invention;

FIG. 7 is a flowchart showing the processing steps of a display data transfer method according to the third embodiment of the present invention;

FIG. 8 is a block diagram illustrating a configuration of a conventional display data transfer apparatus; and

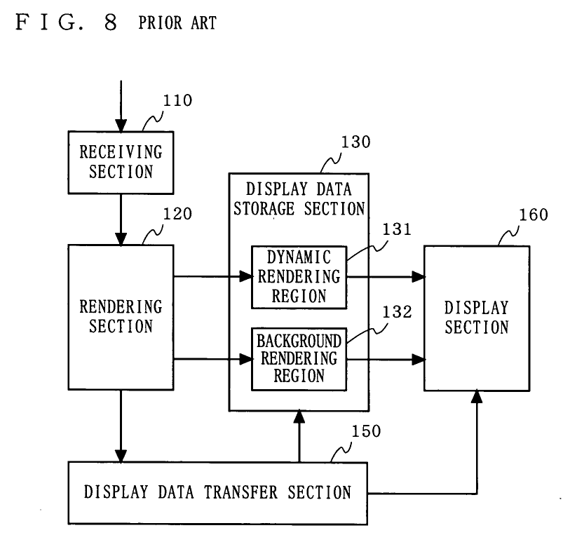

FIG. 9 is a schematic diagram showing an exemplary relationship between pixel positions on a display screen of a display section 160 and regions 94 which are provided in a display data storage section 130 and which store display data of the pixels.

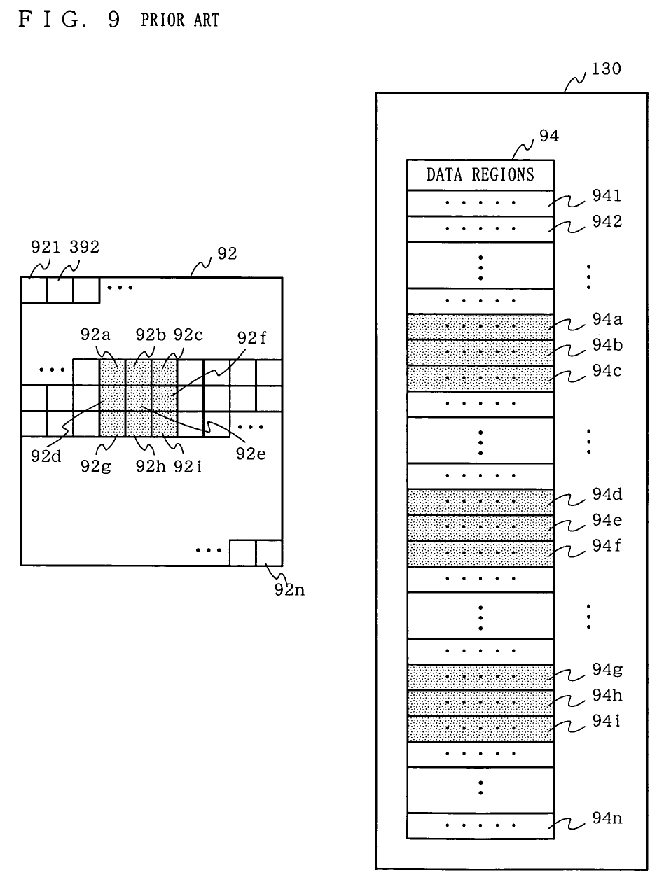

### DESCRIPTION OF THE PREFERRED EMBODIMENTS

With reference to the drawings, embodiments of the present invention will be described below.

(First Embodiment)

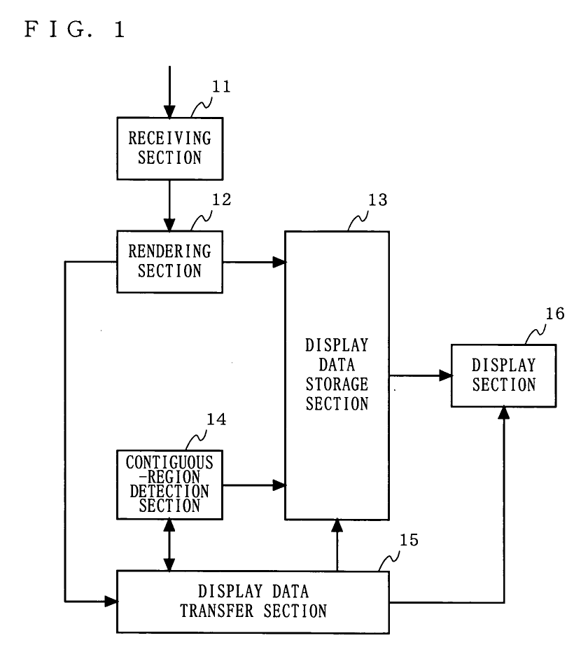

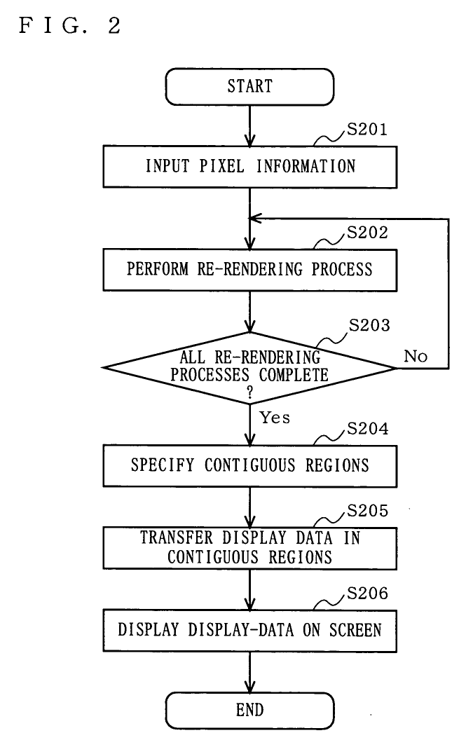

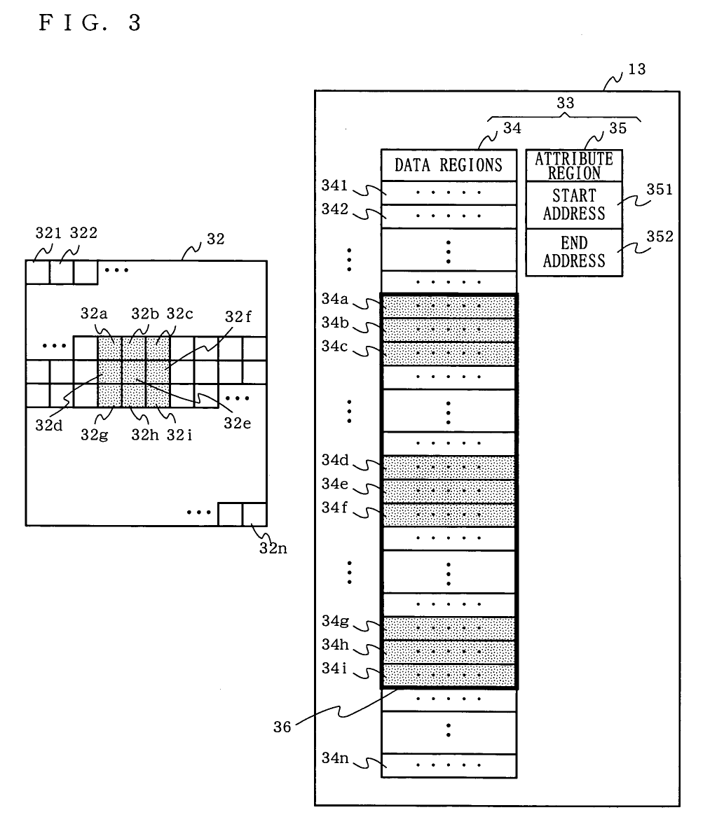

FIG. 1 is a block diagram illustrating a configuration of a display data transfer apparatus according to a first embodiment of the present invention. In FIG. 1, the display data transfer apparatus according to the first embodiment includes a receiving section 11, a rendering section 12, a display data storage section 13, a contiguous-region detection section 14, a display data transfer section 15, and a display section 16. FIG. 2 is a flowchart showing the processing steps of a display data transfer method according to the first embodiment of the present invention. FIG. 3 is a schematic diagram showing an exemplary relationship between pixel positions on a display screen of the display section 16 of FIG. 1 and storage regions 33 which are provided in the display data storage section 13 of FIG. 1 and which store display data of the pixels.

Pixel information about an image to be displayed on the screen of the display section 16 is inputted to the receiving section 11 (step S201). In accordance with the inputted pixel information, the receiving section 11 then instructs the rendering section 12 to re-render display data of a portion of the image which requires updating. Although typically pixel information only about the portion of the image which requires updating is inputted to the receiving section 11, pixel information about the entire screen which additionally includes pixel information about a portion of the image which does not require updating may be inputted. In the latter case, the receiving section 11 should perform the process of determining which portion of the image in one screen is updated. In accordance with the instruction received from the receiving section 11, the rendering section 12 re-renders the display data of the portion of the image which requires updating stored in the display data storage section 13 (step S202).

The display data storage section 13 has a storage region 33 composed of data regions 34 for storing display data for one screen of the display section 16 and an attribute region 35 for storing update information which indicates what range of display data has been updated (re-rendered) (see FIG. 3). The display data storage section 13 stores in contiguous data regions 341 to 34n display data for one screen which is scanned line by line from a top-left pixel 321 of a screen 32 to a bottom-right pixel 32n, as is the case with the conventional display data storage section 130. Further, in the display data storage section 13 illustrated in the example of FIG. 3, update information about display data is stored in the attribute region 35 in the form of a start address 351 and an end address 352. The display data storage section 13 is generally composed of physical memory such as RAM and is allocated in a memory device. Re-rendering by the rendering section 12 is performed such that new display data is stored in a data region 34 corresponding to a portion of the image to be updated and predetermined update information is written to the attribute region 35. Upon completion of re-rendering of the display data of the portion of the image which requires updating, the rendering section 12 notifies the display data transfer section 15 that re-rendering has been completed (step S203).

As shown in FIG. 3, typical update information comprises a start address 351 (offset information) which indicates the lowest physical address of data regions whose display data has been updated, and an end address 352 (offset information) which indicates the highest physical address. In the example of FIG. 3, the physical address of a data region 34a serves as the start address 351 and the physical address of a data region 34i serves as the end address 352. In another configuration, the update information may comprise a start address (offset information) and the number of bytes (size information) of physical memory containing all display data ranging from display data at the start address to display data at the end address. By using such contiguous information, the program or hardware of the computer system can detect information about contiguous regions in the physical memory as identifiable information, making it possible to perform high-speed display data transfer processing.

In still another configuration, the update information may comprise a pixel position (X and Y coordinates) obtained when display data at a start address is displayed on the screen and a pixel position obtained when display data at an end address is displayed on the screen. The coordinate origin of the pixel position may be set such that the pixel position of the top left of the screen (X, Y)=(0, 0), for example. In this case, by enabling the display data transfer section 15 to identify physical addresses of the display data storage section 13 from pixel position information provided by the contiguous-region detection section 14, the contiguous-region detection section 14 no longer needs to understand physical addresses, etc., which strongly depend on the hardware configuration of the computer system. This makes it possible to install the display data transfer apparatus of the present invention on computer systems of different architectures.

In response to the notification from the rendering section 12, the display data transfer section 15 inquires of the contiguous-region detection section 14 about the data regions of the display data storage section 13 whose display data has been updated. In response to the inquiry, the contiguous-region detection section 14 checks on the attribute region 35 of the display data storage section 13 and specifies data regions 36 which include all data regions whose display data has been updated and which are contiguous in the physical memory (step S204). The contiguous-region detection section 14 then provides contiguous information indicating the specified contiguous data regions 36 to the display data transfer section 15.

Note that the contiguous data regions 36 are not necessarily minimum contiguous regions which always starts from a data region (or a pixel position) at the start address 351 and always ends with a data region (or a pixel position) at the end address 352, as long as the contiguous data regions 36 include all data regions whose display data has been updated. For example, a data region of unupdated display data having X and Y coordinates at least either of which is smaller than X or Y coordinate obtained when display data at the start address 351 is displayed on the screen may serve as the start region of the contiguous data regions 36, or a data region of unupdated display data having X and Y coordinates at least either of which is greater than X or Y coordinate obtained when display data at the end address 352 is displayed on the screen may serve as the end region of the contiguous data regions 36. Hence, the configuration or size of the contiguous data region 36 can be freely set taking into account processing efficiency, etc., of the system.

The display data transfer section 15 reads from the display data storage section 13 display data in accordance with the information about the contiguous data regions 36 provided by the contiguous-region detection section 14 and transfers the display data to the display section 16 (step S205). Upon transferring the display data, the display data transfer section 15 also clears the update information written to the attribute region 35 of the display data storage section 13. The display section 16 is composed of a display apparatus such as a CRT or liquid crystal display. The display section 16 receives the display data having been transferred from the display data storage section 13 and then displays the received display data on the screen (step S206). Note that although the present embodiment illustrates the case where the display section 16 is included in the display data transfer apparatus, the display section 16 may be provided separately from the display data transfer apparatus.

As described above, according to the display data transfer apparatus and method of the first embodiment of the present invention, when there has been an update to display data of an image, contiguous regions containing the updated display data are specified. This makes it possible to transfer the contiguous regions to the display section by a single DMA transfer even when the update to the display data is partial. Accordingly, a frequent reading of data from the physical memory can be avoided, and thus an updated image can be displayed without increasing CPU load.

(Second Embodiment)

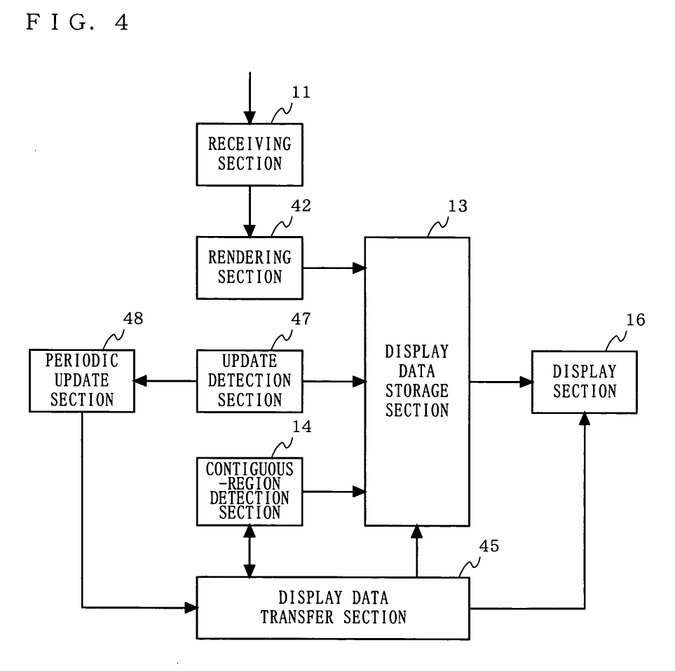

FIG. 4 is a block diagram illustrating a configuration of a display data transfer apparatus according to a second embodiment of the present invention. In FIG. 4, the display data transfer apparatus according to the second embodiment includes a receiving section 11, a rendering section 42, a display data storage section 13, a contiguous-region detection section 14, an update detection section 47, a periodic update section 48, a display data transfer section 45, and a display section 16. As can be seen in FIG. 4, the display data transfer apparatus according to the second embodiment is different from the display data transfer apparatus according to the foregoing first embodiment in that the update detection section 47 and the periodic update section 48 are additionally provided and the rendering section 12 and the display data transfer section 15 are replaced with the rendering section 42 and the display data transfer section 45, respectively.

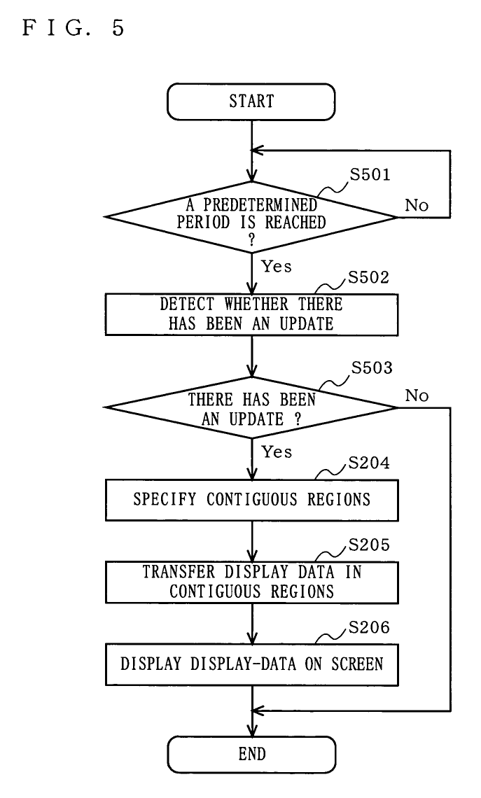

With further reference to FIG. 5, the display data transfer apparatus according to the second embodiment will be described below, focusing on the aforementioned different configurations. FIG.5 is a flowchart showing the processing steps of a display data transfer method according to the second embodiment of the present invention. Note that in FIG. 5, the same processing steps as those of FIG. 2 are designated by the same step numbers.

As in the same manner as the first embodiment, pixel information is inputted to the receiving section 11, and then a re-rendering process is performed by the rendering section 42 (steps S201 and S202). Note that here notification is not provided to the display data transfer section 45 from the rendering section 42. The periodic update section 48 inquires of the update detection section 47 on a predetermined periodic basis whether there has been an update to display data in the display data storage section 13 (step S501). Basically, the control by the periodic update section 48 is performed asynchronously with the re-rendering process performed by the rendering section 42. In response to the inquiry from the periodic update section 48, the update detection section 47 detects whether there has been an update to the display data stored in the display data storage section 13, and provides a detection result to the periodic update section 48 (step S502). The detection is performed based on update information written to an attribute region 35 of the display data storage section 13. If the periodic update section 48 receives a response from the update detection section 47 that there has been an update, the periodic update section 48 instructs the display data transfer section 45 to transfer display data (step S503). In response to the instruction from the periodic update section 48, the display data transfer section 45 inquires of the contiguous-region detection section 14 about the data regions of the display data storage section 13 whose display data has been updated.

As described above, according to the display data transfer apparatus and method of the second embodiment of the present invention, contiguous regions containing updated display data are transferred to the display section on a predetermined periodic basis. This makes it possible to transfer the contiguous regions containing the display data having been updated in a predetermined periodic time to the display section by a single DMA transfer even when re-rendering occurs frequently in a short period of time.

(Third Embodiment)

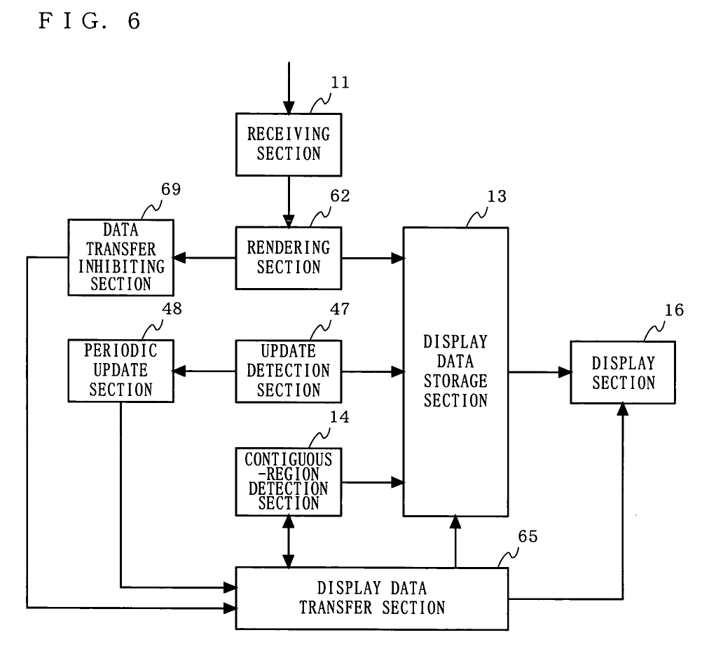

FIG. 6 is a block diagram illustrating a configuration of a display data transfer apparatus according to a third embodiment of the present invention. In FIG. 6, the display data transfer apparatus according to the third embodiment includes a receiving section 11, a rendering section 62, a display data storage section 13, a contiguous-region detection section 14, and an update detection section 47, a periodic update section 48, a data transfer inhibiting section 69, a display data transfer section 65, and a display section 16. As can be seen in FIG. 6, the display data transfer apparatus according to the third embodiment is different from the display data transfer apparatus according to the foregoing second embodiment in that the data transfer inhibiting section 69 is additionally provided and the rendering section 42 and the display data transfer section 45 are replaced with the rendering section 62 and the display data transfer section 65, respectively.

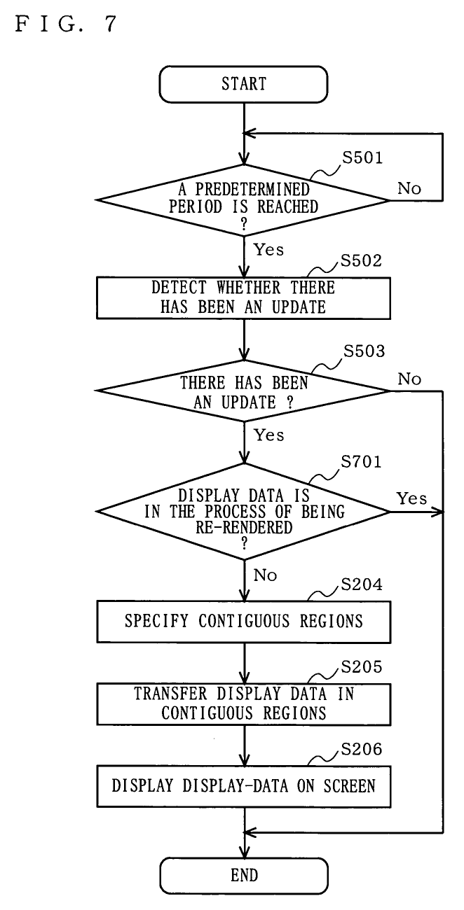

With further reference to FIG. 7, the display data transfer apparatus according to the third embodiment will be described below, focusing on the aforementioned different configurations. FIG. 7 is a flowchart showing the processing steps of a display data transfer method according to the third embodiment of the present invention. Note that in FIG. 7, the same processing steps as those of FIGS. 2 and 5 are designated by the same step numbers.

As in the same manner as the second embodiment, pixel information is inputted to the receiving section 11, and then a re-rendering process is performed by the rendering section 62 (steps S201 and S202). In addition, the rendering section 62 notifies the data transfer inhibiting section 69 about the start and completion times for the re-rendering process. The data transfer inhibiting section 69 controls data transfer such that the display data transfer section 65 does not transfer display data to the display section 16 while the rendering section 62 is performing a rendering process on the display data storage section 13 (step S701). Basically, the control by the data transfer inhibiting section 69 is performed asynchronously with the re-rendering process performed by the rendering section 62. Specifically, when the data transfer inhibiting section 69 is notified by the rendering section 62 that rendering has started, the data transfer inhibiting section 69 instructs the display data transfer section 65 to inhibit data transfer. In addition, when the data transfer inhibiting section 69 is notified by the rendering section 62 that rendering has completed, the data transfer inhibiting section 69 instructs the display data transfer section 65 to clear the inhibition state of the data transfer. Accordingly, even if the display data transfer section 65 is instructed by the periodic update section 48 to transfer display data while data transfer is inhibited, the display data transfer section 65 does not perform an actual data transfer process. That is, the display data transfer section 65 transfers display data to the display section 16 only when there has been an update to display data and data transfer is not inhibited.

As described above, according to the display data transfer apparatus and method of the third embodiment of the present invention, when a re-rendering process is underway, transfer of contiguous regions containing updated display data to the display section is inhibited. This makes it possible to avoid a situation where an incomplete image which is under the process of updating is displayed on the screen of the display section even in the case where a predetermined period is reached while display data for one screen is being written to the display data storage section. In particular, this data transfer inhibiting process exerts a greater effect on systems such as systems with a large display screen size or systems with a slow write speed to the physical memory.

The foregoing first to third embodiments describe the configuration in which the attribute region 35 is provided in the display data storage section 13, the rendering section 12, 42, or 62 stores update information, and the contiguous-region detection section 14 detects contiguous regions by referring to the attribute region 35. In another configuration, the rendering section 12, 42, or 62 may directly notify the contiguous-region detection section 14 about contiguous-region information.

Further, although the foregoing first to third embodiments describe the configuration in which the display section 16 is included in the display data transfer apparatus, the display section 16 maybe provided as a separate apparatus (e.g., a monitor) from the display data transfer apparatus.

Typically, the display data transfer methods described in the foregoing first to third embodiments are realized by the CPU interpreting predetermined program data which is stored in a storage apparatus (e.g., ROM, RAM, a hard disk, etc.) and which is capable of executing the aforementioned processing steps. In this case, the program data may be installed in the storage apparatus via a storage medium such as a CD-ROM or flexible disk, or may be directly executed from a storage medium.

While the invention has been described in detail, the foregoing description is in all aspects illustrative and not restrictive. It is understood that numerous other modifications and variations can be devised without departing from the scope of the invention.

1. A display data transfer apparatus for transferring display data for screen display to a display apparatus, comprising:
a display data storage section for storing display data for one screen of the display apparatus;
a rendering section for rendering and storing in the display data storage section display data to be inputted;
a contiguous-region detection section for detecting display data whose rendering content has been updated from the display data stored in the display data storage section, and specifying contiguous regions which include all regions having stored therein the updated display data and have contiguous physical addresses; and
a display data transfer section for transferring to the display apparatus the display data stored in the contiguous regions specified by the contiguous-region detection section.

2. The display data transfer apparatus according to claim 1, wherein after the rendering section has completed the rendering and storing of the display data, the rendering section provides an instruction permitting transfer execution to the display data transfer section.

3. The display data transfer apparatus according to claim 1, further comprising:
an update detection section for detecting whether there has been an update to rendering content of the display data stored in the display data storage section; and
a periodic update section for inquiring of the update detection section on a predetermined periodic basis whether there has been an update and providing, if there has been an update, an instruction permitting transfer execution to the display data transfer section.

4. The display data transfer apparatus according to claim 3, further comprising:
a data transfer inhibiting section for providing an instruction inhibiting transfer execution to the display data transfer section in the case where the rendering section is under a process of rendering and storing display data in the display data storage section.

5. The display data transfer apparatus according to claim 1, wherein the contiguous regions are represented by offset information providing a lowest physical address of the physical addresses which indicate the storage regions of the updated display data in the display data storage section, and size information providing a range of the updated display data from the lowest physical address to a highest physical address.

6. The display data transfer apparatus according to claim 2, wherein the contiguous regions are represented by offset information providing a lowest physical address of the physical addresses which indicate the storage regions of the updated display data in the display data storage section, and size information providing a range of the updated display data from the lowest physical address to a highest physical address.

7. The display data transfer apparatus according to claim 3, wherein the contiguous regions are represented by offset information providing a lowest physical address of the physical addresses which indicate the storage regions of the updated display data in the display data storage section, and size information providing a range of the updated display data from the lowest physical address to a highest physical address.

8. The display data transfer apparatus according to claim 4, wherein the contiguous regions are represented by offset information providing a lowest physical address of the physical addresses which indicate the storage regions of the updated display data in the display data storage section, and size information providing a range of the updated display data from the lowest physical address to a highest physical address.

9. The display data transfer apparatus according to claim 1, wherein the contiguous regions are represented by starting pixel information providing the smallest X and Y coordinates of the updated display data and ending pixel information providing the largest X and Y coordinates of the updated display data, the X and Y coordinates being obtained when the updated display data is displayed as pixels on a screen of the display apparatus.

10. The display data transfer apparatus according to claim 2, wherein the contiguous regions are represented by starting pixel information providing the smallest X and Y coordinates of the updated display data and ending pixel information providing the largest X and Y coordinates of the updated display data, the X and Y coordinates being obtained when the updated display data is displayed as pixels on a screen of the display apparatus.

11. The display data transfer apparatus according to claim 3, wherein the contiguous regions are represented by starting pixel information providing the smallest X and Y coordinates of the updated display data and ending pixel information providing the largest X and Y coordinates of the updated display data, the X and Y coordinates being obtained when the updated display data is displayed as pixels on a screen of the display apparatus.

12. The display data transfer apparatus according to claim 4, wherein the contiguous regions are represented by starting pixel information providing the smallest X and Y coordinates of the updated display data and ending pixel information providing the largest X and Y coordinates of the updated display data, the X and Y coordinates being obtained when the updated display data is displayed as pixels on a screen of the display apparatus.

13. The display data transfer apparatus according to claim 1, wherein the contiguous regions are represented by starting pixel information providing the X and Y coordinates of a pixel, at least one coordinate being smaller than the smallest X or Y coordinate of the updated display data, and ending pixel information providing the largest X and Y coordinates of the updated display data, the X and Y coordinates being obtained when the updated display data is displayed as pixels on a screen of the display apparatus.

14. The display data transfer apparatus according to claim 2, wherein the contiguous regions are represented by starting pixel information providing the X and Y coordinates of a pixel, at least one coordinate being smaller than the smallest X or Y coordinate of the updated display data, and ending pixel information providing the largest X and Y coordinates of the updated display data, the X and Y coordinates being obtained when the updated display data is displayed as pixels on a screen of the display apparatus.

15. The display data transfer apparatus according to claim 3, wherein the contiguous regions are represented by starting pixel information providing the X and Y coordinates of a pixel, at least one coordinate being smaller than the smallest X or Y coordinate of the updated display data, and ending pixel information providing the largest X and Y coordinates of the updated display data, the X and Y coordinates being obtained when the updated display data is displayed as pixels on a screen of the display apparatus.

16. The display data transfer apparatus according to claim 4, wherein the contiguous regions are represented by starting pixel information providing the X and Y coordinates of a pixel, at least one coordinate being smaller than the smallest X or Y coordinate of the updated display data, and ending pixel information providing the largest X and Y coordinates of the updated display data, the X and Y coordinates being obtained when the updated display data is displayed as pixels on a screen of the display apparatus.

17. The display data transfer apparatus according to claim 1, wherein the contiguous regions are represented by starting pixel information providing the X and Y coordinates of a pixel, at least one coordinate being smaller than the smallest X or Y coordinate of the updated display data, and ending pixel information providing the X and Y coordinates of a pixel, at least one coordinate being larger than the largest X or Y coordinate of the updated display data, the X and Y coordinates being obtained when the updated display data is displayed as pixels on a screen of the display apparatus.

18. The display data transfer apparatus according to claim 2, wherein the contiguous regions are represented by starting pixel information providing the X and Y coordinates of a pixel, at least one coordinate being smaller than the smallest X or Y coordinate of the updated display data, and ending pixel information providing the X and Y coordinates of a pixel, at least one coordinate being larger than the largest X or Y coordinate of the updated display data, the X and Y coordinates being obtained when the updated display data is displayed as pixels on a screen of the display apparatus.

19. The display data transfer apparatus according to claim 3, wherein the contiguous regions are represented by starting pixel information providing the X and Y coordinates of a pixel, at least one coordinate being smaller than the smallest X or Y coordinate of the updated display data, and ending pixel information providing the X and Y coordinates of a pixel, at least one coordinate being larger than the largest X or Y coordinate of the updated display data, the X and Y coordinates being obtained when the updated display data is displayed as pixels on a screen of the display apparatus.

20. The display data transfer apparatus according to claim 4, wherein the contiguous regions are represented by starting pixel information providing the X and Y coordinates of a pixel, at least one coordinate being smaller than the smallest X or Y coordinate of the updated display data, and ending pixel information providing the X and Y coordinates of a pixel, at least one coordinate being larger than the largest X or Y coordinate of the updated display data, the X and Y coordinates being obtained when the updated display data is displayed as pixels on a screen of the display apparatus.

21. A display data transfer method of transferring display data for screen display to a display apparatus through physical memory which stores display data for one screen, the method comprising the steps of:
rendering and storing in a display data storage section display data to be inputted;
detecting display data whose rendering content has been updated from the display data stored in the display data storage section;
specifying contiguous regions which include all regions having stored therein the updated display data and have contiguous physical addresses; and
transferring to the display apparatus the display data stored in the specified contiguous regions.

22. A program for allowing a computer to perform a method of transferring display data for screen display to a display apparatus through physical memory which stores display data for one screen, the program comprising the steps of:
rendering and storing in a display data storage section display data to be inputted;
detecting display data whose rendering content has been updated from the display data stored in the display data storage section;
specifying contiguous regions which include all regions having stored therein the updated display data and have contiguous physical addresses; and
transferring to the display apparatus the display data stored in the specified contiguous regions.

23. A computer-readable storage medium having stored thereon a program which allows a computer to perform a method of transferring display data for screen display to a display apparatus through physical memory which stores display data for one screen, the program comprising the steps of:
rendering and storing in a display data storage section display data to be inputted;
detecting display data whose rendering content has been updated from the display data stored in the display data storage section;
specifying contiguous regions which include all regions having stored therein the updated display data and have contiguous physical addresses; and
transferring to the display apparatus the display data stored in the specified contiguous regions.
